(19) United States
(12) Patent Application Publication
(10) Pub. No.: US 2015/0094855 A1
(43) Pub. Date: Apr. 2, 2015

(54) IMITATION LEARNING METHOD FOR A MULTI-AXIS MANIPULATOR

(71) Applicant: Leoni CIA Cable Systems SAS, Gellainville (FR)

(72) Inventors: Jérôme Chemouny, Saint Remy Les Chevreuse (FR); Stéphane Clerambault, Gometz-Le-Chatel (FR); Samuel Pinault, Chevreuse (FR)

(21) Appl. No.: 14/398,928

(22) PCT Filed: May 3, 2013
(86) PCT No.: PCT/EP2013/059298

§ 371 Date: Nov. 4, 2014

(30) Foreign Application Priority Data
May 4, 2012 (EP) 12166888.3

(51) Int. Cl. B25J 9/16; B25J 9/06; B25J 9/02

(52) U.S. Cl. CPC B25J 9/163; B25J 9/023; B25J 9/06; Y10S 901/03; Y10S 901/09; Y10S 901/47
USPC 700/259; 700/245; 700/262; 901/3; 901/9; 901/47

(57) ABSTRACT

The present invention concerns an imitation learning method for a multi-axis manipulator (7,7′). This method comprises the steps of capturing, at a set of successive waypoints (10,11) in a teach-in trajectory (4) of a user-operated training tool, spatial data comprising position and orientation of the training tool (3) in a Cartesian space; selecting, from among said set of successive waypoints (10,11), a subset of waypoints (11) starting from a first waypoint (11) of said set of successive waypoints (10,11), wherein for each subsequent waypoint (11) to be selected a difference in position and/or orientation with respect to a last previously selected waypoint (11) exceeds a predetermined threshold; fitting a set trajectory (4′) in said Cartesian space to said selected subset of waypoints (11); and converting said set trajectory into motion commands in a joint space of said multi-axis manipulator (7,7′).

### TECHNICAL FIELD

The disclosure relates to an imitation learning method, as well as to a computer program for implementing such a method, a computer device programmed so as to implement this method, and a robotic system comprising such a computer device and a multi-axis manipulator.

### BACKGROUND

In the present context, “imitation learning”, also known as “learning by demonstration” or “programming by demonstration”, refers to methods allowing a robotic system to learn a set of actions by having them performed by an operator, so as to replicate them. Such imitation learning methods may be applied in a large variety of fields including, for instance, industrial or medical robotics. They may not just be used to program a robotic system for later replication of the actions of the human operator, but also for remote operation purposes, where one or several remote multi-axis manipulators replicate the actions of the human operator in real time.

Imitation learning methods facilitate the programming of a robotic system, and in particular of a robotic system comprising at least one multi-axis manipulator, and this even by operators without particular programming skills. Instead, the manual dexterity of the programming manipulator becomes crucial in ensuring a smooth, efficient motion to be replicated by the robotic system.

Nevertheless, even the most skilled human operator may be unable to achieve the smoothness and accuracy that can be achieved by a robotic system. Exact replication of the actions of a human operator will thus limit the potential of the robotic system to improve on the dexterity of the human operator.

### SUMMARY

Consequently, a first object of the present disclosure is that of providing an imitation learning method whereby a robotic system can learn to perform a set of operation with even higher accuracy and efficiency than a human user whose operations are to be replicated.

Accordingly, in at least one illustrative embodiment, this imitation learning method may comprise at least the steps of:
capturing, at a set of successive waypoints in a teach-in trajectory of a user-operated training tool, spatial data comprising position and orientation of the training tool in a Cartesian space;
selecting, from among said set of successive waypoints, a subset of waypoints starting from a first point of said set of successive waypoints, wherein for each subsequent waypoint to be selected a difference in position and/or orientation with respect to a last previously selected waypoint exceeds a predetermined threshold;
fitting a set trajectory in said Cartesian space to said selected subset of waypoints; and
converting said set trajectory into motion commands in a joint space of said multi-axis manipulator.

The capture step provides the input of spatial data corresponding to the operation of the training tool by the user. However, thanks to the subsequent waypoint selection step, it is possible to filter, from the teach-in trajectory, small user hesitations and deviations, thus resulting in a smoother set trajectory on whose basis the motion commands for the individual joints of the multi-axis manipulator will then be obtained. Said motion commands may be transmitted to a multi-axis manipulator in real time, for the remote operation of said multi-axis manipulator through the user-operated training tool. Alternatively or complementarily to this transmission, however, these motion commands may be stored for subsequent input to a multi-axis manipulator.

If the multi-axis manipulator is not infinitely redundant in the Cartesian space of the set trajectory, the conversion of the set trajectory into motion commands in a joint space of the multi-axis manipulator may be performed using an inverse kinematic model of the multi-axis manipulator.

However, said multi-axis manipulator may alternatively be infinitely redundant in said Cartesian space, and said conversion step then comprise the calculation of an optimal path of redundant joint positions maximizing Yoshikawa index values for the multi-axis manipulator along the set trajectory. In this context, “redundant joint position” is understood as meaning a positional value in the joint space axis corresponding to a redundant joint. If the redundant joint is a rotating joint, this redundant joint position will have an angular value. By determining a position for each redundant joint, it is possible to solve the positions of the remaining joints. To each position vector of the multi-axis manipulator in joint space corresponds a Jacobian matrix which is the transformation matrix from joint speed vector to the speed vector of an end-effector of the multi-axis manipulator in Cartesian space. The Yoshikawa index is a manipulability index defined as the square root of the determinant of the product of this Jacobian matrix and its transverse. Maximizing the Yoshikawa index increases the accuracy of the multi-axis manipulator while reducing the joint speeds during its motion.

The calculation of said redundant joint trajectory may in particular comprise the steps of:
selecting a plurality of alternative redundant joint starting positions for a first point in said set trajectory;
calculating, for each one of said alternative initial redundant joint positions, a path of successive redundant joint positions by selecting, for each successive point in the set trajectory, the redundant joint position resulting in the highest Yoshikawa index value for the multi-axis manipulator and complying with predetermined speed and/or acceleration limits with respect to the previous redundant joint position in the same path of successive redundant joint positions;
interpolating, between said paths of successive redundant joint positions, a plurality of polynomial redundant joint trajectories; and
extracting said optimal path from redundant joint positions in said plurality of polynomial redundant joint trajectories, for example by using an optimization algorithm. This optimization algorithm may be in particular a least-squares algorithm such as, for example, the Nelder-Mead algorithm, a genetic algorithm or a neural network such as, for example, a multilayer neural network.

In order to ensure the quality of the optimal path, it may be subsequently validated using an accuracy index corresponding to a ratio of Cartesian space to joint space variation along said optimal path and/or an energy index corresponding to joint speeds in joint space along said optimal path.

The abovementioned spatial data comprising position and orientation of the training tool in the Cartesian space may be captured through an optical sensor and in particular a stereoscopic sensor, although other optical sensors suitable for capturing tridimensional positional data, such as for instance time-of-flight sensors, may alternatively be used.

In order to identify both position and orientation of the training tool with such an optical sensor, said user-operated training tool may carry at least a first marker and two additional markers spaced along different axes from said first marker. To ensure redundancy, so that both position and orientation of the learning can be identified even in low visibility conditions, a set of markers may be used comprising four markers of which no more than two are co-linear.

Alternatively to the use of an optical sensor, however, said user-operated training tool may be carried by a multi-axis manipulator, a manual operation of said user-operated training tool being servo-assisted by the multi-axis manipulator carrying the user-operated training tool, and said spatial data being captured through joint position sensors of the multi-axis manipulator carrying the user-operated training tool. For said servo-assistance, user force inputs may for instance be sensed by force sensors at the training tool and converted into joint actuator commands for the multi-axis manipulator carrying the user-operated training tool.

The disclosed imitation-learning method may in particular be computer-implemented. Consequently, the present disclosure also relates to a computer program for implementing such an imitation learning method, to a computer-readable data storage medium containing an instruction set for implementing such an imitation learning method, to a computing device programmed with an instruction set for carrying out such an imitation learning method, and to a robotic system comprising such a computing device and a multi-axis manipulator connected to it for its control.

The above summary of some example embodiments is not intended to describe each disclosed embodiment or every implementation of the invention. In particular, selected features of any illustrative embodiment within this specification may be incorporated into an additional embodiment unless clearly stated to the contrary.

### BRIEF DESCRIPTION OF THE DRAWINGS

The invention may be more completely understood in consideration of the following detailed description of various embodiments in connection with the accompanying drawings, in which:

FIGS. 1A and 1B illustrate, respectively, the manual operation of a user-operated training tool, and the subsequent replication of this operation by a six-axis manipulator following an imitation learning method according to a first embodiment;

FIG. 2 illustrates a set of four visual markers mounted on the user-operated training tool of FIGS. 1A and 1B for tracking with an optical sensor;

FIG. 3 illustrates the manual operation of a user-operated training tool, and the real-time replication of this operation by several six-axis manipulators following an imitation learning method according to a second embodiment;

FIG. 4 illustrates, respectively, the manual operation of a user-operated training tool carried by a six-axis manipulator, for a subsequent or real-time replication of this operation by the same or another multi-axis manipulator following an imitation learning method according to a third embodiment;

FIG. 5 is a flowchart illustrating the selection of waypoints in the trajectory of the user-operated training tool;

FIGS. 6A and 6B illustrate the transition from the trajectory of the user-operated training tool to a smoother set trajectory for a replicating multi-axis manipulator;

FIG. 7 illustrates an infinitely redundant seven-axis manipulator;

FIG. 8 is a flowchart illustrating the conversion of a set trajectory into motion commands for the joints of an infinitely redundant multi-axis manipulator;

FIG. 9A is a graph illustrating the evolution of the Yoshikawa index over time for several different alternative paths of successive redundant joint positions for a given end-effector set trajectory for an infinitely redundant multi-axis manipulator, each path having a different first redundant joint position, as well as for a plurality of polynomial redundant joint trajectories interpolated from said paths; and

FIG. 9B is a graph highlighting an optimal path extracted from the plurality of polynomial joint trajectories of FIG. 9A.

While the invention is amenable to various modifications and alternative forms, specifics thereof have been shown by way of example in the drawings and will be described in detail. It should be understood, however, that the intention is not to limit aspects of the invention to the particular embodiments described. On the contrary, the intention is to cover all modifications, equivalents, and alternatives falling within the scope of the invention.

### DETAILED DESCRIPTION

For the following defined terms, these definitions shall be applied, unless a different definition is given in the claims or elsewhere in this specification.

As used in this specification and the appended claims, the singular forms “a”, “an”, and “the” include plural referents unless the content clearly dictates otherwise. As used in this specification and the appended claims, the term “or” is generally employed in its sense including “and/or” unless the content clearly dictates otherwise.

The following detailed description should be read with reference to the drawings in which similar elements in different drawings are numbered the same. The detailed description and the drawings, which are not necessarily to scale, depict illustrative embodiments and are not intended to limit the scope of the invention. The illustrative embodiments depicted are intended only as exemplary. Selected features of any illustrative embodiment may be incorporated into an additional embodiment unless clearly stated to the contrary.

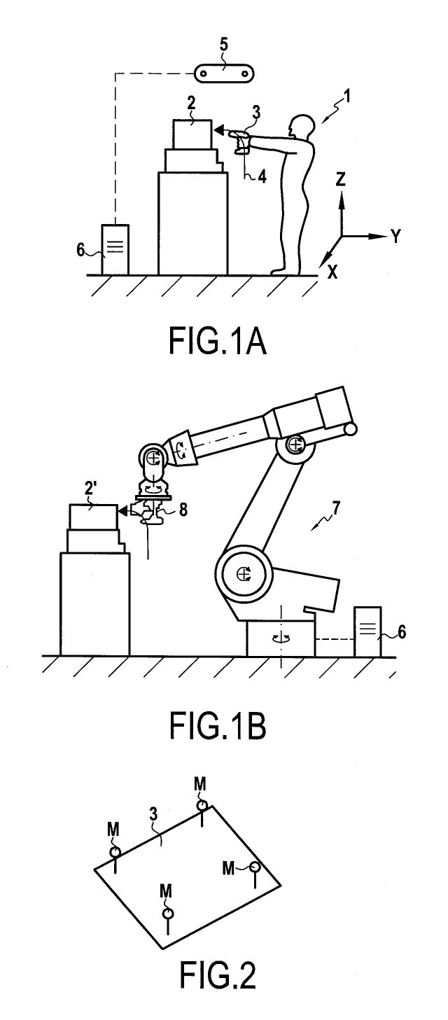

Imitation learning is known to be a useful and particularly user-friendly technique for programming complex operations in multi-axis manipulators. FIGS. 1A and 1B illustrate a first embodiment of such an imitation learning technique in which a human operator 1 first performs a complex operation on a workpiece 2 using a teaching tool 3, whose trajectory 4 during this operation is tracked by a sensor 5 and stored in a data storage unit within a computing device 6 connected to said sensor 5, as shown in FIG. 1A. In particular, sensor 5 captures spatial data comprising the position and orientation of teaching tool 3, at waypoints spaced by regular time intervals during this operation, in a Cartesian space with three orthogonal reference axes X,Y,Z. For this, the teaching tool 3 may in particular carry at least three, preferably four markers, offset from each other in at least two different axes, whose individual positions can be identified by sensor 5. Of these three, preferably four markers, no more than two are co-linear, so that the orientation of the teaching tool 3 in said Cartesian space can be inferred from the relative positions of the markers. FIG. 2 illustrates an example of such a set of four markers M mounted on a surface of teaching tool 3 in a quadrangular configuration.

Sensor 5 may in particular be an optical sensor, and more specifically a stereoscopic sensor, generating two laterally offset images whose parallax can then be used to infer depth data. However, various other types of sensors suitable for providing three-dimensional position data may be considered, such as for instance so-called time-of-flight sensors.

As shown in FIG. 1B, the spatial data stored in computing device 6 can then be processed to generate motion commands for a multi-axis manipulator 7 to replicate trajectory 4 with a working tool 8 carried at its end-effector, in order to reproduce the same operation on workpiece 2′. In the particular embodiment illustrated in FIG. 1B, the multi-axis manipulator 7 is a six-axis manipulator with six rotating joints. However, the same method may be analogously applied with manipulators having different numbers or types of joints, including both rotating and/or linear joints.

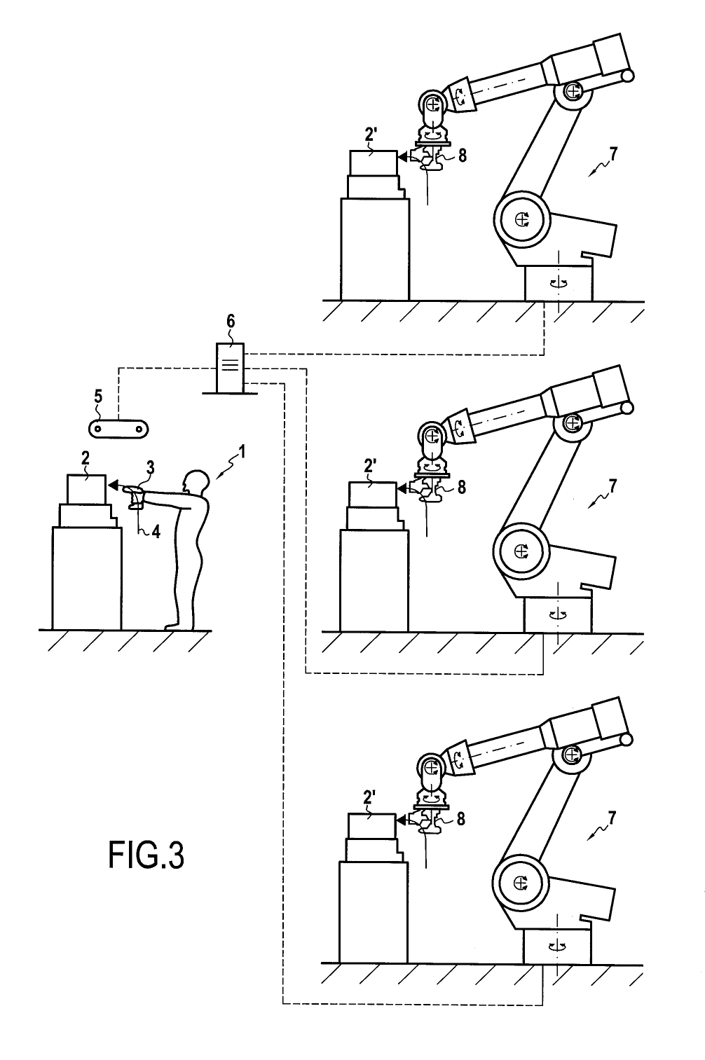

While in the first embodiment illustrated in FIGS. 1A and 1B the imitation learning method is used to programme the robotic system 9 formed by computing device 6 and multi-axis manipulator 7 for a subsequent replication of the operations carried out by the human operator, such an imitation learning method may also be used for real-time remote control of one or several multi-axis manipulators 7 operating simultaneously or near-simultaneously to the human operator 1, as shown in the embodiment illustrated in FIG. 3. In this second embodiment, the incoming spatial data from sensor 5 are processed in real time to produce the motion commands transmitted to all three multi-axis manipulators 7 connected to computing device 6.

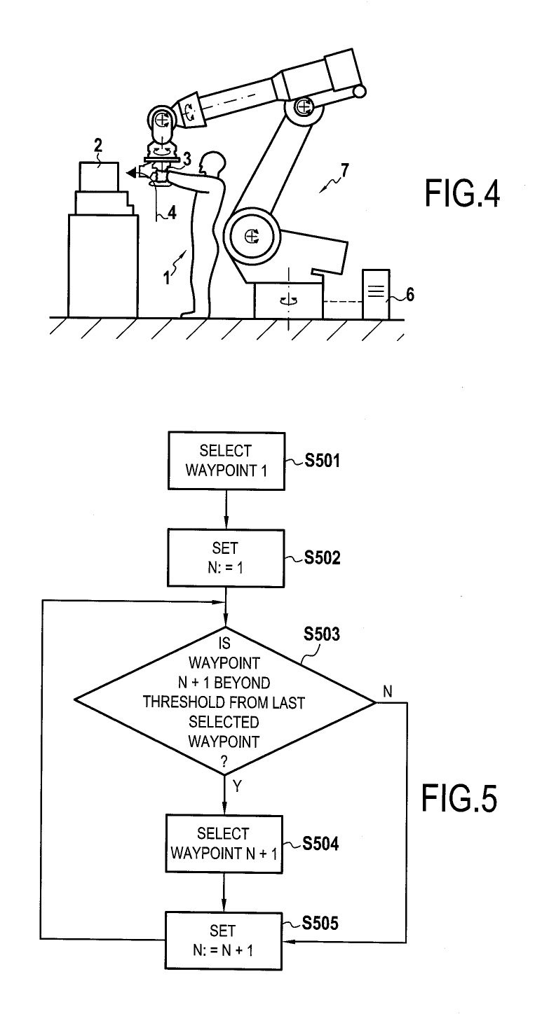

While an optical sensor 5 is used in both the first and second illustrated embodiments, alternative arrangements may also be used to capture the position and orientation of a user-operated teaching tool 3. In the third embodiment illustrated in FIG. 4, teaching tool 3, while held by the human operator 1, is already mounted on the end-effector of multi-axis manipulator 7. Force sensors installed in teaching tool 3 receive force inputs from the human operator 1, and transmit them to the computing device 6 which issues corresponding commands to actuators in the joints of multi-axis manipulator 7 in order to servo-assist the operations of the human operator 7. Simultaneously, joint position sensors in each joint of multi-axis manipulator 7 transmit the position of each joint in joint space to computing device 6, which processes these data using the direct kinematic model of the multi-axis manipulator 7 to infer spatial data including position and orientation of user-operated teaching tool 3 in Cartesian space. As in the previous embodiments, these spatial data can then be processed by computing device 6 to generate motion commands for the same or another multi-axis manipulator 7 to replicate the teach-in trajectory 4 of teaching tool 3, either subsequently or in real time.

In each embodiment, the computing device may be a conventional programmable computer running a computer program implementing these methods. This computer program may be in the shape of a set of instructions stored in a memory carrier. In the present context, “memory carrier” and “data storage medium” should be understood as meaning any physical medium capable of containing data readable by a reading device for at least a certain period of time. Examples of such memory carriers are magnetic tapes and discs, optical discs (read-only as well as recordable or re-writable), logical circuit memories, such as read-only memory chips, random-access memory chips and flash memory chips, and even more exotic data storage media, such as chemical, biochemical or mechanical memories.

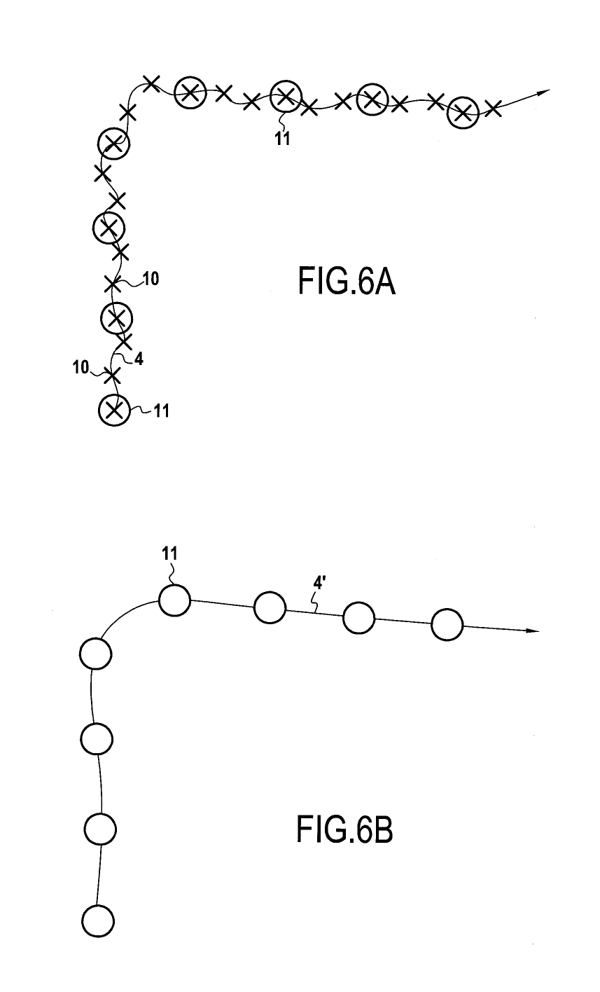

Even a highly-skilled, highly-dexterous human operator will be unable to suppress some tremor and hesitation during his operation. FIG. 5 illustrates a waypoint selection routine aimed at filtering this operator-induced noise in the spatial data while replicating as much as possible the accuracy of his operations. In a first step S501 is this routine, a first waypoint in teach-in trajectory 4 is selected. In the next step S502, the value of a counter n is set to 1. It is then checked, in step S503, whether a distance from the last selected waypoint to the next waypoint, that is, waypoint n+1, is beyond a predetermined threshold. This distance may be a distance along a single axis in abovementioned Cartesian space, an absolute distance in a two-dimensional plane in said Cartesian space, or an absolute distance in said Cartesian space. Different thresholds may also be used for different axes or planes in said Cartesian space. If waypoint n+1 is indeed beyond that threshold from the last selected waypoint, it is then also selected in step S504 before adding one unit to counter n in step S505 and jumping back to step S503. If waypoint n+1 is not beyond that threshold from the last selected waypoint, the routine goes directly from step S503 to step S505 without selecting waypoint n+1. The result of this routine is illustrated on FIGS. 6A and 6B. FIG. 5A shows a teach-in trajectory 4 and waypoints 10, 11 corresponding to training tool spatial data captured at regular time intervals along said teach-in trajectory 4. Following the selection routine, only waypoints 11 are selected, on which a smoother set trajectory 4′ can then be fitted. This waypoint selection routine offers a trade-off between accuracy and motion smoothness. Increasing the selection threshold will reduce the accuracy while increasing the smoothness of set trajectory 4′.

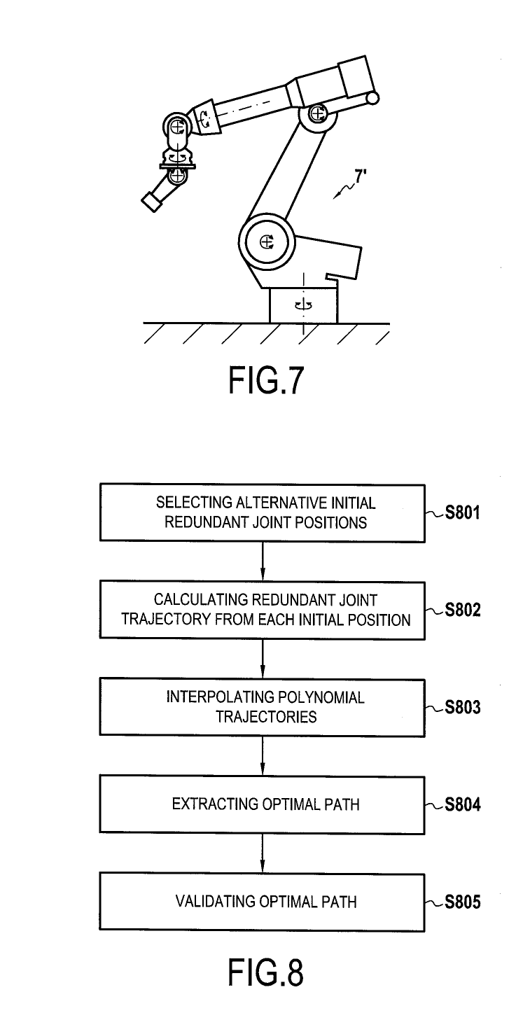

In a three-dimensional Cartesian space, a six-axis manipulator, such as those illustrated in FIGS. 1A,1B, 3 and 4, is finitely redundant, that is, offers only a finite number of solutions in joint space for a given end-effector position and orientation in the Cartesian space. Consequently, the step of converting a set trajectory for the end-effector in Cartesian space into motion commands in joint space can be carried out using an inverse kinematic model of the six-axis manipulator and well-known singularity avoidance algorithms, relying for instance on the Yoshikawa index, on singularity avoidance by angular velocity inputs, or on the damped least-squares method. With at least one additional joint, however, like the seven-axis manipulator 7′ illustrated in FIG. 7, the manipulator becomes infinitely redundant, offering an infinite number of solutions in joint space for a given end-effector position and orientation in the Cartesian space. With this infinite number of solutions, it becomes possible to select those offering optimal manipulability, increasing accuracy and decreasing energy requirements.

A suitable indicator of the manipulability of a multi-axis manipulator is the Yoshikawa index p, defined by the equation:

μ=\sqrt{det(J·J^{T})}

wherein J is the Jacobian matrix of the multi-axis manipulator, that is, the matrix determining the relationship between end-effector velocities \dot{X} in the Cartesian space and joint velocities \dot{q} in joint space, according to the equation:

\dot{X}=J*\dot{q}

For example, with a seven-axis manipulator with seven serially arranged rotational joints, this equation can be expressed as:

$$( \begin{matrix}\dot{x} \\ \dot{y} \\ \dot{z} \\ \dot{α} \\ \dot{β} \\ \dot{γ}\end{matrix} ) = J * ( \begin{matrix}{\dot{θ}}_{1} \\ {\dot{θ}}_{2} \\ {\dot{θ}}_{3} \\ {\dot{θ}}_{4} \\ {\dot{θ}}_{5} \\ {\dot{θ}}_{6} \\ {\dot{θ}}_{7}\end{matrix} )$$

wherein \dot{x}, \dot{y} and ż are linear speeds of the end-effector in three orthogonal axes in the Cartesian space, \dot{α}, \dot{β} and \dot{γ} are angular speeds of the end-effector around three orthogonal axes in the Cartesian space, and \dot{θ}₁ to \dot{θ}₇ are angular speeds of each one of the seven rotational joints around their respective rotation axes.

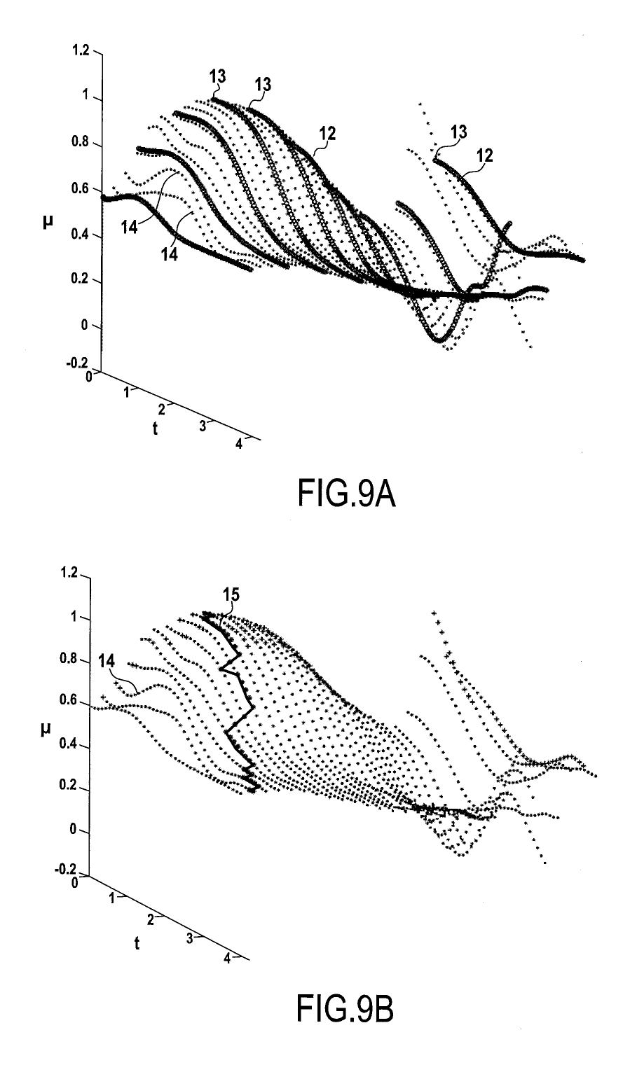

FIG. 8 illustrates a process suitable for providing and validating an optimal path of redundant joint positions in an infinitely redundant manipulator which maximizes Yoshikawa index values along the set trajectory for the end-effector. In a first step S801 in this process, several alternative initial redundant joint positions are selected. This selection may combine randomly or semi-randomly selected initial redundant joint positions with initial redundant joint positions offering a comparatively high value of the Yoshikawa index p. In the next step S802, a path of successive redundant joint positions is calculated for each initial redundant joint position by selecting, for each successive waypoint in the set trajectory, the redundant joint position resulting in the highest Yoshikawa index value for the multi-axis manipulator and complying with predetermined speed and/or acceleration limits with respect to the previous redundant joint position in the same path of successive redundant joint positions. FIG. 9A illustrates an example showing the evolution over time t of the Yoshikawa index p for a plurality of paths 12 of redundant joint positions, each one starting from a different initial redundant joint position 13 at t=0. In the next step S803, a plurality of polynomial trajectories 14, also reflected in FIG. 9A, is interpolated between the paths 12. From the redundant joint positions in these polynomial trajectories 13 it is then possible in step S804 to extract an optimal path 15 maximizing the value of the Yoshikawa index μ along the entire set trajectory, as shown in FIG. 9B, by using one of several alternative approaches.

In a second, alternative approach, the optimal path 15 is extracted by using an optimization algorithm to optimize the coefficients of a linearized polynomial redundant joint trajectory maximizing the value of the Yoshikawa index μ. In particular, a least-squares optimization algorithm such as the Nelder-Mead algorithm may be used, although other alternative optimization algorithms, like for example a genetic algorithm, or a neural network, such as a multilayer perceptron neural network, may also be considered.

The resulting optimal path 15 for the redundant joint in joint space may then be validated in step S805 using an accuracy and/or an energy index calculated over the whole path. For each position, the accuracy index C_{accuracy} corresponds to a relationship between positional change of the manipulator end-effector in Cartesian space and corresponding changes of the joint positions in joint space. The direct kinematic model of a seven-axis manipulator with seven serial rotational joints can be expressed as a matrix T_{1,7} fulfilling the equation:

$$( \begin{matrix}x \\ y \\ z \\ α \\ β \\ γ\end{matrix} ) = {T}_{1 , 7} * ( \begin{matrix}{θ}_{1} \\ {θ}_{2} \\ {θ}_{3} \\ {θ}_{4} \\ {θ}_{5} \\ {θ}_{6} \\ {θ}_{7}\end{matrix} )$$

wherein x, y and z are the positions of the manipulator end-effector in the three orthogonal axes of the Cartesian space, α, β and γ are orientation angles of the manipulator end-effector around respective orthogonal axes of the Cartesian space and θ₁ to θ₇ are angular positions of each one of the seven rotational joints around their respective rotation axes. Using this direct kinematic model T_{1,7} it is also possible to determine the effect on the position and orientation of the end-effector of small variations in the joint angles. Thus, for a position in joint space, with given joint angles θ₁ to θ₇, it is possible to calculate an error vector ΔX according to the following equation:

$$\begin{matrix}Δ X = ( \begin{matrix}Δ x \\ Δ y \\ Δ z \\ Δ α \\ Δ β \\ Δ γ\end{matrix} ) \\ = {\sum }_{p = 1}^{P} {\sum }_{r = 1}^{R} {\sum }_{s = 1}^{S} {\sum }_{t = 1}^{T} {\sum }_{u = 1}^{U} {\sum }_{v = 1}^{V} {\sum }_{w = 1}^{W} [ \begin{matrix}{T}_{1 , 7} * ( \begin{matrix}{θ}_{1} \\ {θ}_{2} \\ {θ}_{3} \\ {θ}_{4} \\ {θ}_{5} \\ {θ}_{6} \\ {θ}_{7}\end{matrix} ) - \\ {T}_{1 , 7} * ( \begin{matrix}{θ}_{1} + Δ {θ}_{1 , p} \\ {θ}_{2} + Δ {θ}_{2 , r} \\ {θ}_{3} + Δ {θ}_{3 , s} \\ {θ}_{4} + Δ {θ}_{4 , t} \\ {θ}_{5} + Δ {θ}_{5 , u} \\ {θ}_{6} + Δ {θ}_{6 , v} \\ {θ}_{7} + Δ {θ}_{7 , w}\end{matrix} )\end{matrix} ]\end{matrix}$$

wherein Δθ_{i,j} correspond to small variations in the respective joint angle θᵢ. For instance, for each joint i, three different variations may be chosen, Δθ_{i,1}=−0.1 rad, Δθ_{i,2}=0.0 rad, and Δθ_{i,3}=+0.1 rad. A scalar value can be calculated for the accuracy index C_{accuracy} on the basis of this error vector ΔX, according to the following equation:

C_{accuracy}=\sqrt{(Δx²+Δy²+Δz²)}+Δα+Δβ+Δγ

Consequently, this accuracy index C_{accuracy} decreases with increasing accuracy of the manipulator, that is, decreasing positional sensitivity of the end-effector to changes in the joint positions.

The energy index C_{energy} is based on the instantaneous joint speeds for all manipulator axes along said optimal path. For an infinitely redundant multi-axis manipulator with m rotational axes in series, it can be calculated as the average of the absolute values of the angular speeds \dot{θ}ᵢ, of the axes i=1 to n, according to the following equation:

$${C}_{energy} = \frac{{\sum }_{i = 1}^{m} \vert {\dot{θ}}_{l} \vert}{m}$$

Consequently, this energy index C_{energy} reflects the speed of the joints at each point in the optimal path. Both the accuracy index C_{accuracy} and the energy index C_{energy} will spike near a singularity in joint space. Therefore, both these indexes, or either one of them, may be used to validate said optimal path, for instance by setting maximum thresholds for each index, or a single threshold for a sum of both indexes.

Those skilled in the art will recognize that the present invention may be manifested in a variety of forms other than the specific embodiments described and contemplated herein. Accordingly, departure in form and detail may be made without departing from the scope of the present invention as described in the appended claims.

1. An imitation learning method for a multi-axis manipulator, comprising the steps of:
capturing, at a set of successive waypoints in a teach-in trajectory of a user-operated training tool, spatial data comprising position and orientation of the training tool in a Cartesian space;
selecting, from among said set of successive waypoints, a subset of waypoints starting from a first waypoint of said set of successive waypoints, wherein for each subsequent waypoint to be selected a difference in position and/or orientation with respect to a last previously selected waypoint exceeds a predetermined threshold;
fitting a set trajectory in said Cartesian space to said selected subset of waypoints; and
converting said set trajectory into motion commands in a joint space of said multi-axis manipulator.

2. An imitation learning method according to claim 1, wherein said conversion step is performed using an inverse kinematic model of the multi-axis manipulator.

3. An imitation learning method according to claim 1, wherein said multi-axis manipulator is infinitely redundant in said Cartesian space, and said conversion step comprises the calculation of an optimal path of redundant joint positions maximizing Yoshikawa index values for the multi-axis manipulator along the set trajectory.

4. An imitation learning method according to claim 3, wherein the calculation of said optimal path comprises:
selecting a plurality of alternative initial redundant joint positions for a first waypoint in said set trajectory;
calculating, for each one of said alternative initial redundant joint positions, a path of successive redundant joint positions by selecting, for each successive waypoint in the set trajectory, the redundant joint position resulting in the highest Yoshikawa index value for the multi-axis manipulator and complying with predetermined speed and/or acceleration limits with respect to the previous redundant joint position in the same path of successive redundant joint positions;
interpolating, between said paths of successive redundant joint positions, a plurality of polynomial redundant joint trajectories; and
extracting said optimal path from redundant joint positions in said plurality of polynomial redundant joint trajectories.

5. An imitation learning method according to claim 4, wherein said optimal path is extracted using an optimization algorithm.

6. An imitation learning method according to claim 3, wherein said optimal path is validated using an accuracy index corresponding to a ratio of Cartesian space to joint space variation along said optimal path.

7. An imitation learning method according to claim 3, wherein said optimal path is validated using an energy index corresponding to joint speeds in joint space along said optimal path.

8. An imitation learning method according to claim 1, wherein said spatial data are captured through an optical sensor.

9. An imitation learning method according to claim 8, wherein said optical sensor is a stereoscopic sensor.

10. An imitation learning method according to claim 1, wherein said user-operated training tool carries at least a first marker and two additional markers spaced along different axes from said first marker.

11. An imitation learning method according to claim 1, wherein said user-operated training tool is carried by a multi-axis manipulator, a manual operation of the training tool being servo-assisted by the multi-axis manipulator carrying the user-operated training tool, and said spatial data being captured through joint position sensors of the multi-axis manipulator carrying the user-operated training tool.

12. An imitation learning method according to any one of the previous claims, wherein said motion commands are transmitted to a multi-axis manipulator in real time.

13. A computer program for implementing an imitation learning method according to any one of the previous claims.

14. A computer-readable data storage medium containing an instruction set for implementing an imitation learning method according to any one of claims 1 to 12.

15. A computing device programmed with an instruction set for carrying out an imitation learning method according to any one of claims 1 to 12.

16. A robotic system comprising a multi-axis manipulator connected to a computing device programmed with an instruction set for carrying out an imitation learning method according to any one of claims 1 to 12.
